(19) United States
(12) Patent Application Publication
(10) Pub. No.: US 2004/0065270 A1
(43) Pub. Date: Apr. 8, 2004

(54) Pet stroller

(76) Inventor: Lise King, Port Washington, NY (US)

Correspondence Address: WILLIAM COLLARD, COLLARD & ROE, P.C., 1077 NORTHERN BOULEVARD, ROSLYN, NY, 11576, US

(21) Appl. No.: 10/663,465

(22) Filed: Sep. 16, 2003

Related U.S. Application Data
(60) Provisional application No. 60/411,366, filed on Sep. 17, 2002.

(51) Int. Cl. A01K 1/03

(52) U.S. Cl. 119/496

(57) ABSTRACT

A pet stroller having an enclosure mounted in a tray provided in the bottom section of a frame. The frame has a tray located in its bottom section, a handle for pushing the pet stroller and wheels for rolling along a surface. The enclosure has a flexible material secured to its frame which covers the outer section and at least one end of the enclosure. The flexible material may be a netting material such as fish netting. The enclosure also has a door releasably secured to an end of the enclosure. A fabric layer may be provided on the bottom section of the enclosure.

### CROSS REFERENCE TO RELATED APPLICATIONS

This application claims the benefit of U.S. Provisional Application No. 60/411,366 filed Sep. 17, 2002.

### BACKGROUND OF THE INVENTION

1. Field of the Invention

This invention relates to a stroller for use in transporting small animals. In particular, the invention relates to a collapsible pet enclosure that is attachable to a frame with wheels for transporting the pet.

2. The Prior Art

It is often desirable to take one's pet along for a stroll around one's neighborhood, both as a diversion for the pet and as exercise for the owner. Larger pets are often walked on leashes, also giving the pet exercise. Smaller pets such as house cats are generally not “walked” because they do not need enforced exercise and are usually trained to use a litter box. However, many owners still desire to give these pets fresh air and entertainment and would like to take such pets on walks. However, due to their small size, this is not practical or safe.

### SUMMARY OF THE INVENTION

It is therefore desirable to provide a safe and comfortable environment in which a pet can be walked with the owner.

This and other objects are accomplished by a stroller for a pet, comprising a frame having two sides, a bottom, at least three wheels and a handle for pushing the frame, and a collapsible pet enclosure adapted to be mounted within the frame and to hold a pet, so that the frame can be pushed along a surface with the pet riding in the stroller.

The frame is preferably made of metal tubing that is welded or screwed together. There are preferably four wheels, two in front and two in back. The wheels are preferably rubber and the front wheels are mounted so that they can rotate sideways, for steering the stroller around a corner.

The bottom of the frame comprises a solid tray for supporting the pet enclosure.

The pet enclosure is similar to that disclosed in U.S. patent application Ser. No. 09/952,053, the disclosure of which is herein incorporated by reference.

The pet enclosure comprises a plurality of frame pieces connected via flexible netting. The frame pieces each comprise a semicircular hoop and a cross-bar extending between the two legs of the frame at the bottom. The frame piece could also have other shapes, such as rectangular, triangular, etc., as long as it provides a sufficient cross-section for the animal to move. The frame pieces are preferably made of a strong, weather resistant material, such as aluminum, steel or heavy plastic.

The hoop portion is covered in a netting material, which allows light and air through, but cannot be easily torn by an animal's teeth or claws. A suitable material for this purpose is fish netting, which is a wide-weave nylon net material. Other materials could also be used. The frame pieces are arranged parallel with each other in a line, and covered by the netting material, to form an oblong container. The bottom of the enclosure is covered in a durable fabric, which cannot be torn by the animal's claws, but which forms a comfortable surface for the animal to rest on.

At one end of the enclosure, there is a door piece attached, to let the animal in and out. The door is preferably formed of one of the frame pieces. The face of the frame is covered by netting and is pivotally attached along the crossbar to the end frame piece. The top of the door is then releasably secured to the top of the end frame piece. To let the animal in and out, the top of the door is released and the door folds down to open the enclosure. The door could also be secured by a zipper around the entire circumference of the door.

The netting is preferably attached to the frame pieces via rope or string that is wrapped through the holes in the netting and around each frame piece. Other means of attachment could also be used, such as adhesives, rivets, binding, etc.

One half of the length of the enclosure is also preferably covered in a durable, water resistant fabric, thus providing a covered space for the animal to sit in the event of inclement weather. The enclosure is preferably about 26 inches long, with 13 inches being covered in the fabric and the remaining 13 inches being open with just the netting covering the frame.

The frame itself is preferably collapsible as well, so that the entire assembly is easily carried and stored.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a perspective view of the frame according to the invention;

FIG. 2 shows a perspective view of the pet enclosure according to the invention; and

FIG. 3 shows a perspective view of the pet enclosure mounted in the frame.

### DETAILED DESCRIPTION OF THE PREFERRED EMBODIMENT

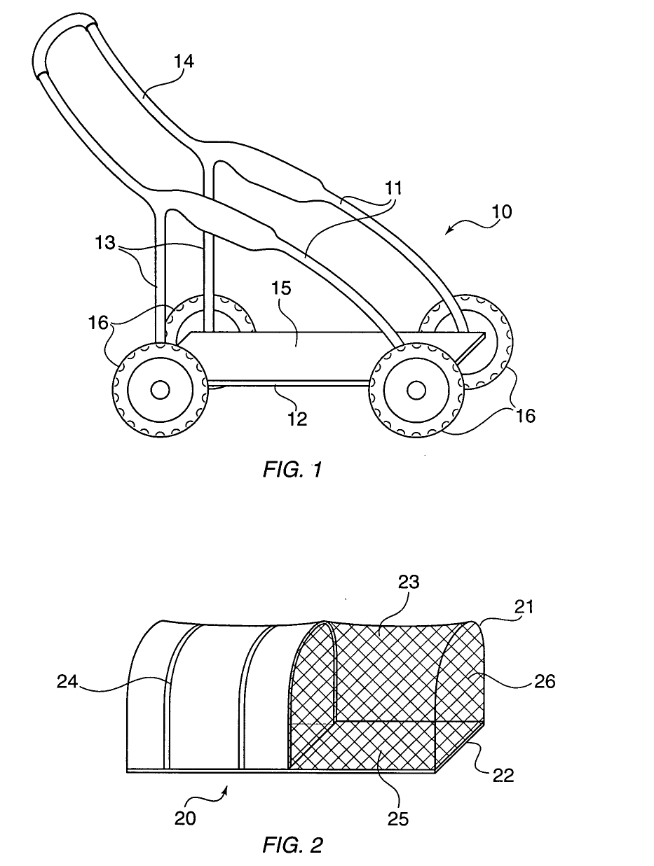

Referring now in detail to the drawings, FIG. 1 shows the frame 10 according to the invention. Frame 10 comprises a bottom section 12 supporting a tray 15, side rails 11 and rear rails 13, which are connected to a handle 14. There are four wheels 16 rotatably mounted to frame 10 to allow frame 10 to roll along a surface. Wheels 16 are preferably rubber. Frame 10 is preferably made of metal tubing but other materials could be used.

FIG. 2 shows animal enclosure 20 according to the invention. Enclosure 20 comprises a plurality of metal frame components comprising a rounded hoop portion 21 and a crossbar 22. Netting 23 is mounted around the hoop portions and a heavy fabric 25 is mounted on crossbars 22. Enclosure 20 is collapsible by bringing all of frame components together. A fabric cover 24 is mounted over at least some of the frame components to protect an animal from sun or precipitation.

There is a door 26 mounted onto an end of enclosure 20 to let the animal in and out of enclosure 20. Door 26 is made of one of the frame components 21 covered in netting 23. Door 26 is secured to enclosure 20 via string or a zipper. Other securing devices could also be used.

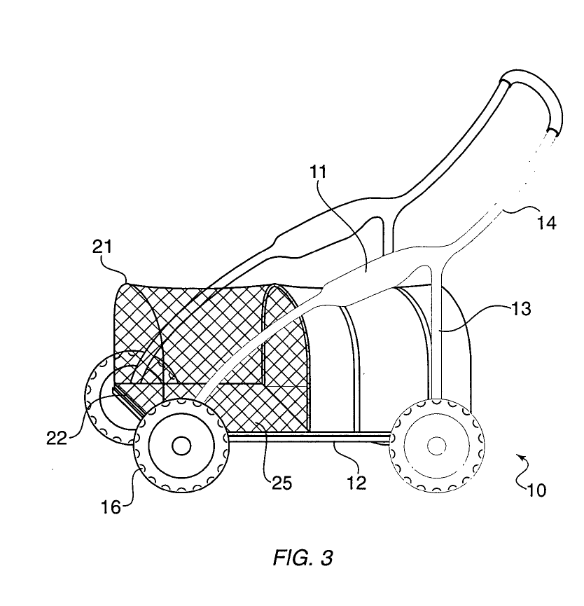

As shown in FIG. 3, enclosure 20 is mounted in frame 10 by placing enclosure 20 on tray 15. Tray 15 is made of stiff and durable material and is made to hold the weight of enclosure 20 and a small animal. Side rails 11 prevent enclosure 20 from falling off of frame 10 during use. During use, the animal can sit comfortably either out in the open air or inside the tent formed from cover 24. The stroller according to the invention could be made in many different sizes, but a preferable size for the enclosure is 26 inches in length and 16 inches in height. The frame 10 is preferably about 16 inches wide and 26 ½ inches long and has a handle height of about 39 inches.

Accordingly, while only a single embodiment of the present invention has been shown and described, it is obvious that many changes and modifications may be made thereunto without departing from the spirit and scope of the invention.

What is claimed:

1. A pet stroller comprising:
a) a frame comprising;
i) a bottom section,
ii) a tray disposed on said bottom section,
iii) a handle disposed on said frame,
iv) a plurality of wheels rotatably secured to said frame; and
b) an enclosure comprising;
i) an enclosure frame forming a bottom section of said enclosure, an outer section of said enclosure, and a plurality of end sections of said enclosure,
ii) a flexible material secured to said enclosure frame and covering said outer section of said enclosure and at least one of said plurality of end sections of said enclosure, and
iii) a door releasably secured to at least one of said plurality of end sections of said enclosure;
wherein said enclosure is mounted in said frame by placing said enclosure on said tray.

2. The pet stroller according to claim 1, further comprising a fabric layer disposed on said bottom section of said enclosure.

3. The pet stroller according to claim 1, wherein said frame comprises a plurality of side rails secured to said bottom section and a plurality of rear rails secured to said bottom section.

4. The pet stroller according to claim 3, wherein said plurality of side rails and said plurality of rear rails are comprised of metal tubing.

5. The pet stroller according to claim 4, wherein said metal tubing is welded or screwed together.

6. The pet stroller according to claim 1, wherein said flexible material is secured to said enclosure frame with adhesive, rivets or binding.

7. The pet stroller according to claim 1, wherein said flexible material comprises netting material.

8. The pet stroller according to claim 7, wherein said netting material comprises fish netting.

9. The pet stroller according to claim 7, wherein said netting material is secured to said enclosure frame by rope or string which is wrapped through a hole in said netting material and around said enclosure frame.

10. The pet stroller according to claim 1, wherein said enclosure frame comprises a plurality of frame components.

11. The pet stroller according to claim 10, wherein said plurality of frame components comprise a plurality of semicircular hoop portions and a plurality of crossbars.

12. The pet stroller according to claim 1, further comprising a durable, water resistant material disposed on a portion of said outer section of said enclosure.

13. The pet stroller according to claim 12, wherein said durable water-resistant material disposed on a portion of said outer section of said enclosure covers approximately one half of the length of said enclosure.

14. The pet stroller according to claim 1, wherein said enclosure is collapsible.

15. The pet stroller according to claim 1, wherein said frame is collapsible.

16. The pet stroller according to claim 1, wherein each of said plurality of wheels is comprised of rubber.

17. The pet stroller according to claim 1, wherein at least one of said plurality of wheels can rotate sideways for steering the pet stroller.

18. The pet stroller according to claim 1, wherein said plurality of wheels comprises four wheels.

19. The pet stroller according to claim 1, wherein said enclosure frame is constructed from a strong weather-proof material selected from the group consisting of aluminum, steel and heavy plastic.

20. The pet stroller according to claim 1, wherein said door is releasably secured to at least one of said plurality of end sections of said enclosure by a zipper.
